(19) United States
(12) Patent Application Publication
(10) Pub. No.: US 2026/0349185 A1
(43) Pub. Date: Nov. 5, 2026

(54) BOOT ASSEMBLY AND CONNECTOR

(71) Applicant: Sumitomo Electric Optifrontier Co., Ltd., Yokohama-shi (JP)

(72) Inventors: Tetsuya KAWAGOE, Kanagawa (JP); Masahiro SHIBATA, Kanagawa (JP); Sho YAKABE, Kanagawa (JP)

(73) Assignee: Sumitomo Electric Optifrontier Co., Ltd., Yokohama-shi (JP)

(21) Appl. No.: 19/538,367

(22) Filed: Feb. 12, 2026

(30) Foreign Application Priority Data
Mar. 11, 2025 (JP) 2025-038660

(51) Int. Cl. G02B 6/38

(52) U.S. Cl. CPC G02B 6/3825

(57) ABSTRACT

A boot assembly according to an embodiment is a boot assembly for a connector connectable to an adapter along a first direction and detachable from the adapter by being pulled in a second direction opposite to the first direction. The boot assembly includes a boot extending from a housing of the connector in the second direction, and a connecting component that connects the boot to the housing. The boot includes a retaining portion that prevents the boot from coming off in the second direction relative to the connecting component. The connecting component includes a fixing portion to be fixed to the housing and a space allowing the retaining portion to move by a predetermined distance relative to the connecting component along the second direction.

### CROSS REFERENCE TO RELATED APPLICATIONS

This application claims priority based on Japanese Patent Application No. 2025-038660 filed on Mar. 11, 2025, and the entire contents of the Japanese patent application are incorporated herein by reference.

### TECHNICAL FIELD

The present disclosure relates to a boot assembly and a connector.

### BACKGROUND

Patent literature (U.S. Patent Application Publication No. 2021/0191053) describes a flexible boot attachable to a fiber optic connector. The flexible boot has a rear portion, a middle portion, and a transition portion located between the rear portion and the middle portion. Four front extensions extend from the middle portion. Two of the four front extensions constitute an upper portion of the front extensions, and the remaining two constitute a lower portion of the front extensions. A projection and a groove located rearward the projection are formed on each of a lower surface of the upper portion of the front extending portions and an upper surface of the lower portion of the front extending portions. The groove has a forward facing surface and a rearward facing surface.

The fiber optic connector is inserted between the upper portion and the lower portion of the forward extensions. The fiber optic connector includes a housing having openings and ribs. The ribs of the housing engage the grooves of the flexible boot. When the flexible boot is pulled rearward, the rearward facing surface of the groove retracts the rib, thereby moving the housing rearward. The flexible boot has a pair of front extensions arranged along a width direction of the flexible boot and a cut out located between the pair of front extending portions. The cut out makes the front extensions more flexible. Thus, the fiber optic connector can be easily inserted between the upper portion and the lower portion of the front extensions.

### SUMMARY

A boot assembly according to the present disclosure is a boot assembly for a connector connectable to an adapter along a first direction and detachable from the adapter by being pulled in a second direction opposite to the first direction. The boot assembly includes a boot extending from a housing of the connector in the second direction, and a connecting component configured to connect the boot to the housing. The boot includes a retaining portion configured to prevent the boot from coming off in the second direction relative to the connecting component. The connecting component includes a fixing portion to be fixed to the housing and a space allowing the retaining portion to move by a predetermined distance relative to the connecting component along the second direction.

### BRIEF DESCRIPTION OF THE DRAWINGS

FIG. 1 is a perspective view showing a connector according to an embodiment.

FIG. 2 is a perspective view of a connector according to an embodiment, as viewed from a direction different from that in FIG. 1.

FIG. 3 is a cross-sectional view of a connector cut along a plane passing through an axis of the connector of FIG. 1.

FIG. 4 is a perspective view showing a state in which a boot assembly according to an embodiment is removed from a housing.

FIG. 5 is a perspective view showing a boot of the boot assembly of FIG. 4.

FIG. 6 is a perspective view showing a connecting component of the boot assembly of FIG. 4.

FIG. 7 is a perspective view showing a boot and a connecting component of the boot assembly of FIG. 4.

FIG. 8 is a perspective view showing a state in which a boot is connected to the connecting component of FIG. 7.

FIG. 9 is a perspective view showing a boot, a first housing, and a second housing according to an embodiment.

FIG. 10 is a perspective view showing a boot, a connecting component, and a first housing according to an embodiment.

FIG. 11 is a perspective view showing a boot, a first housing, and a second housing according to an embodiment.

FIG. 12 is a perspective view showing a boot according to an embodiment.

FIG. 13 is a perspective view showing a first housing and a connecting component according to an embodiment.

FIG. 14 is a perspective view showing a boot, a first housing, and a second housing according to a modification.

FIG. 15 is a perspective view showing a boot, a first housing, and a second housing according to a modification.

FIG. 16 is an enlarged perspective view of a boot and a first housing according to a modification.

### DETAILED DESCRIPTION

A material of a boot connected to a housing of a connector may be a soft material. In this case, when an external force is applied to the boot, the boot may bend, causing the boot to be unintentionally detached from the housing. Thus, it is required to make the boot less likely to be detached from the housing.

An object of the present disclosure is to provide a boot assembly and a connector that can make a boot less likely to be detached.

According to the present disclosure, it is possible to make a boot less likely to be detached.

### Description of Embodiments of Present Disclosure

First, embodiments of a boot assembly and a connector according to the present disclosure will be listed and described. (1) A boot assembly according to the embodiment is a boot assembly for a connector connectable to an adapter along a first direction and detachable from the adapter by being pulled in a second direction opposite to the first direction. The boot assembly includes a boot extending from a housing of the connector in the second direction, and a connecting component configured to connect the boot to the housing. The boot includes a retaining portion configured to prevent the boot from coming off in the second direction relative to the connecting component. The connecting component includes a fixing portion to be fixed to the housing and a space allowing the retaining portion to move by a predetermined distance relative to the connecting component along the second direction.

In this boot assembly, the boot extends from the housing of the connector in the second direction. The boot assembly includes the connecting component, and the connecting component connects the boot to the housing. The boot has the retaining portion that prevents the boot from coming off in the second direction relative to the connecting component fixed to the housing. The connecting component has the fixing portion fixed to the housing and the space allowing the retaining portion of the boot to move by a predetermined distance relative to the connecting component along the second direction. Thus, when the boot is pulled in the second direction, the retaining portion moves a predetermined distance relative to the connecting component, and the retaining portion prevents the boot from coming off relative to the housing and the connecting component. Even if the boot is pulled, the boot is prevented from coming off from the housing and the connecting component, and thus the boot can be made less likely to be detached.

(2) In the above (1), a material of the connecting component may be harder than a material of the boot. In this case, the material of the connecting component is harder than the material of the boot, and thus it is possible to reduce deflection of the connecting component when an external force is applied. Thus, the boot assembly can be prevented from coming off from the housing.

(3) In the above (1) or (2), the boot may be rotatable relative to the connecting component about an axis extending along the first direction. The retaining portion may be a protruding portion protruding in a direction away from the axis. In this case, the retaining portion is the protruding portion, and thus the retaining portion can be easily visually recognized.

(4) In any one of the above (1) to (3), the space may be an opening recessed from an end portion of the connecting component in the first direction toward the second direction. In this case, the configuration of the space can be simplified.

(5) In any one of the above (1) to (4), the connecting component may include a tubular portion configured to house an end portion of the boot in the first direction. The tubular portion may include a slit extending in the first direction from an end portion of the tubular portion in the second direction. In this case, tilting of the boot located inside the tubular portion can be reduced, and movement of the boot can be stabilized.

(6) In any one of the above (1) to (5), the fixing portion may be a fixing hole configured such that the connecting component is fixed to the housing by a projection formed in the housing entering the fixing hole. In this case, the shape of the fixing portion of the connecting component can be simplified.

(7) A connector according to the embodiment includes the above-described boot assembly, and a housing to which the connecting component of the boot assembly is fixed. The connector includes the above-described boot assembly, and thus effects similar to those of the above-described boot assembly can be obtained.

(8) In the above (7), the housing may include a projection. The connecting component may include a fixing hole configured such that the connecting component is fixed to the housing by the projection entering the fixing hole. The projection may include an inclined portion where a projection height of the projection decreases toward the second direction. In this case, the connecting component is fixed to the housing by the projection of the housing entering the fixing hole. The projection includes the inclined portion where the projection height is decreased toward the second direction, which is the direction in which the boot is pulled. Thus, since the projection height of the projection increases toward the first direction, which is the direction in which the boot is pushed, it is possible to more reliably prevent the projection from disengaging when the boot is pulled in the second direction.

(9) In the above (7) or (8), the housing may have a projection and a hole portion recessed around the projection. In this case, the hole portion is formed around the projection, and thus the projection can be easily deflected.

### Details of Embodiments of Present Disclosure

Hereinafter, specific examples of a boot assembly and a connector according to the embodiment will be described with reference to the drawings. In the description of the drawings, the same or corresponding elements are denoted by the same reference numerals, and redundant description will be omitted as appropriate. In the drawings, some parts may be simplified or exaggerated for easy understanding, and the dimensional ratios and the like are not limited to those shown in the drawings.

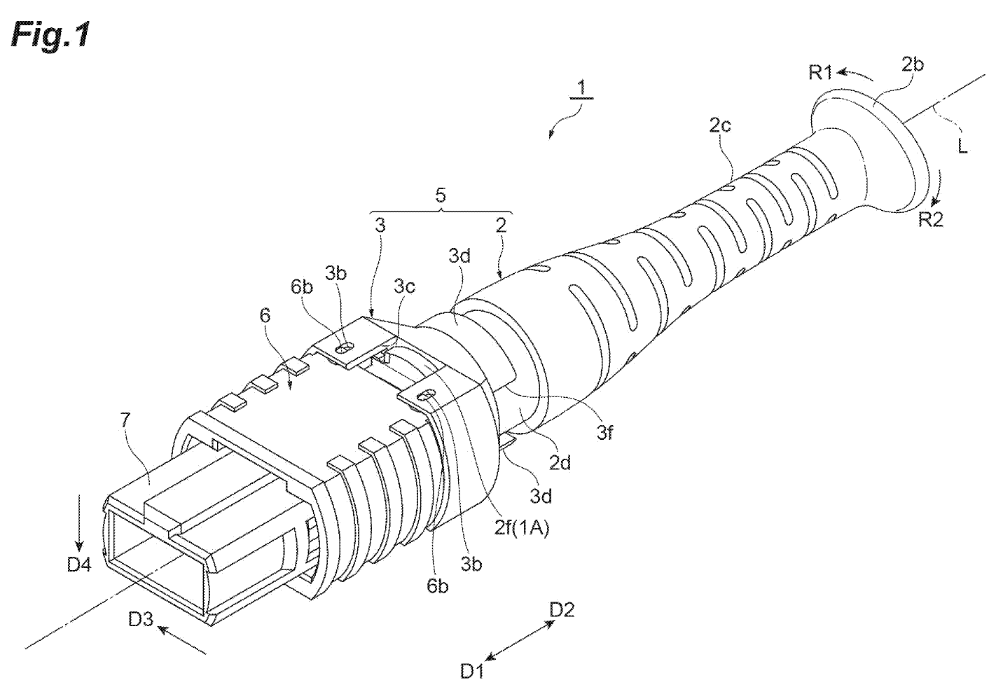

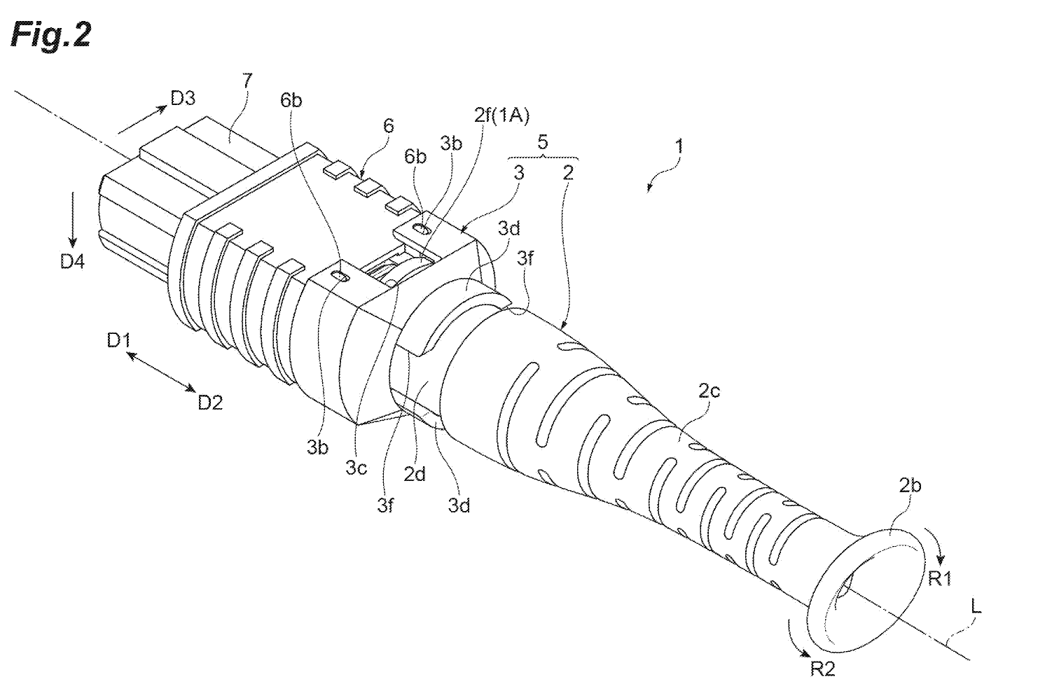

FIG. 1 is a perspective view showing a connector 1 as an example according to the embodiment. FIG. 2 is a perspective view showing the connector 1 as viewed from a direction different from that in FIG. 1. As shown in FIGS. 1 and 2, in the embodiment, the connector 1 is an MPO connector. The connector 1 is connectable to an adapter along a first direction D1. The connector 1 is detachable from the adapter by being pulled in a second direction D2 opposite to the first direction D1.

The connector 1 includes a boot assembly 5, an inner housing 7 covering a ferrule (not shown), and a first housing 6 (housing) that is an outer housing covering a part of the inner housing 7. The boot assembly 5 includes a boot 2 extending from the first housing 6 of the connector 1 in the second direction D2, and a connecting component 3 connecting the boot 2 to the first housing 6.

The boot assembly 5, the first housing 6, and the inner housing 7 are arranged in this order along the first direction D1. When viewed along the second direction D2, the inner housing 7 has a rectangular shape having a long side extending in a third direction D3 orthogonal to the first direction D1 (second direction D2) and a short side extending in a fourth direction D4 orthogonal to both the first direction D1 and the third direction D3. For example, the third direction D3 is a width direction of the connector 1, and the fourth direction D4 is a height direction of the connector 1.

In the following description, the first direction D1 may be referred to as a front, a front side, or forward, and the second direction D2 may be referred to as a rear, a rear side, or rearward. However, these directions are for convenience of description, and do not limit the arrangement position or orientation of an object. A plurality of optical fibers forming a fiber cord are inserted into the boot 2 from the rearward. The ferrule has, for example, a plurality of fiber holes for holding optical fibers, and each of the plurality of optical fibers is inserted into and held in a respective one of the plurality of fiber holes.

The boot 2 is rotatable relative to the connecting component 3 about an axis L extending along the first direction D1. The axis L extends along the first direction D1 inside the boot 2, inside the connecting component 3, inside the first housing 6, and inside the inner housing 7. The connecting component 3 is fixed to the first housing 6. The boot 2 is rotatable about the axis L in a first rotation direction R1 and a second rotation direction R2 opposite to the first rotation direction R1. A rotation angle of the boot 2 about the axis L is, for example, 40° to 50°. The rotation angle of the boot 2 about the axis L may be, for example, larger than 50°, and is not particularly limited. As an example, the first rotation direction R1 is a clockwise direction when the connector 1 is viewed from the rearward, and the second rotation direction R2 is a counterclockwise direction when the connector 1 is viewed from the rearward.

A material of the connecting component 3 is harder than a material of the boot 2. For example, the boot 2 includes rubber, and the connecting component 3 includes a material harder than rubber. The connecting component 3 contains, for example, polyetherimide (PEI) or polybutylene terephthalate (PBT). The material of the connecting component 3 may be the same as any one of a material of the first housing 6, a material of the inner housing 7, or a material of a second housing 8.

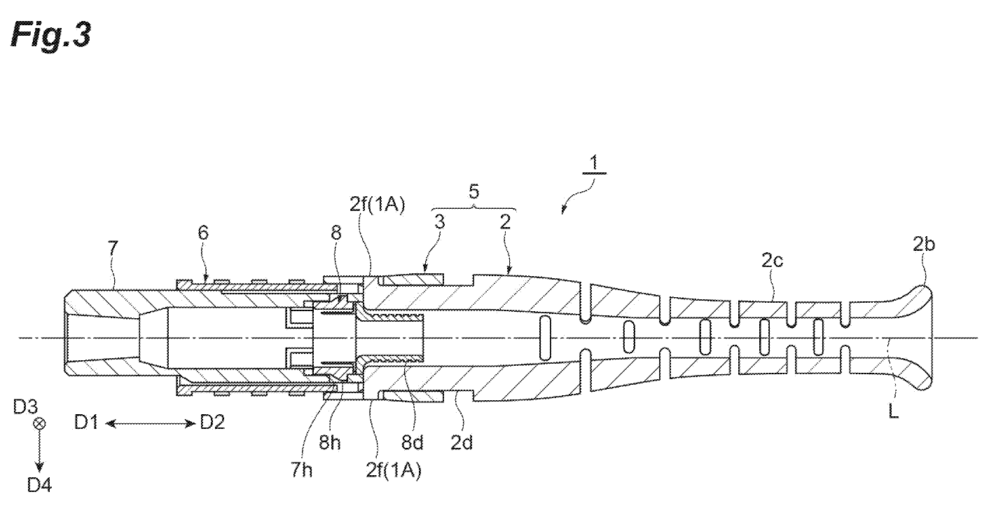

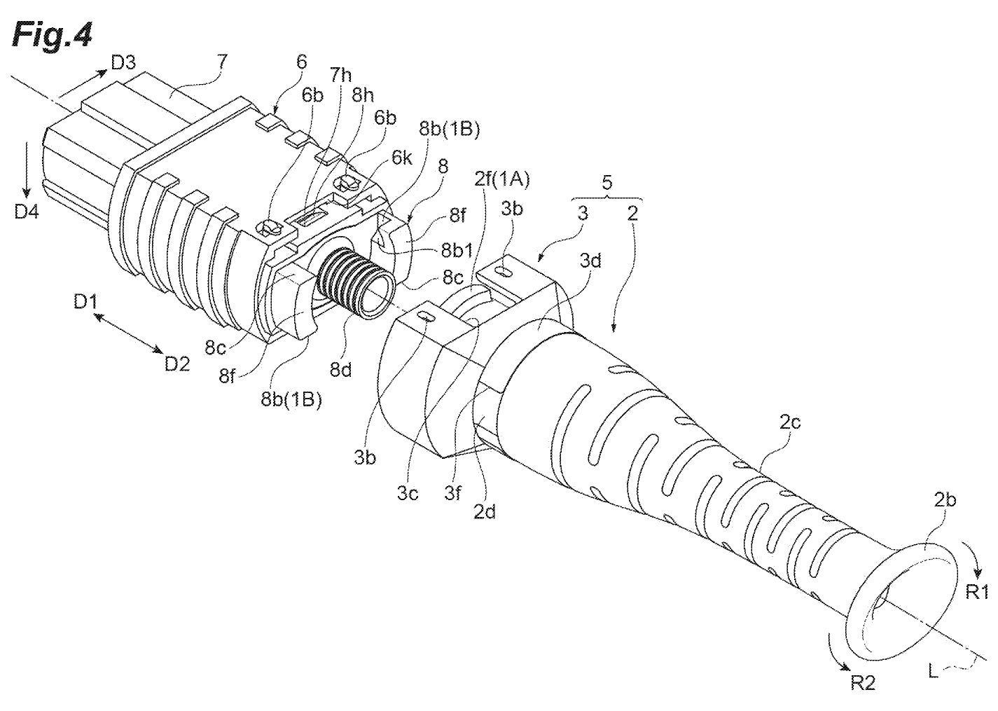

FIG. 3 is a view showing a cross section of the connector 1 when cut by a plane including the axis L. FIG. 4 is a perspective view showing a state in which the boot assembly 5 is removed from the first housing 6. As shown in FIGS. 3 and 4, the first housing 6 has a recessed portion 6k recessed in the first direction D1 from an end portion of the first housing 6 in the second direction D2. When viewed along the fourth direction D4, the recessed portion 6k has a squared U-shape. The connector 1 has the second housing 8 connected to the inner housing 7. The second housing 8 is located inside the first housing 6. The second housing 8 is, for example, a rear housing having an end portion of the second housing 8 in the second direction D2 protruding from the first housing 6. The first housing 6 and the inner housing 7 are fixed by a spring (not shown), and are movable relative to each other along the first direction D1 and the second direction D2.

The inner housing 7 has a protruding portion that engages with a latch of the adapter. In each of FIGS. 3 and 4, the illustration of the protruding portion of the inner housing 7 is omitted. The connector 1 is connected to the adapter by engaging the protruding portion of the inner housing 7 with the latch of the adapter. For example, the inner housing 7 has a through hole 7h penetrating the inner housing 7 in the fourth direction D4, and the second housing 8 has a protruding portion 8h protruding along the fourth direction D4. The second housing 8 is fixed to the inner housing 7 by fitting the protruding portion 8h into the through hole 7h. The boot 2 extends from the second housing 8 in the second direction D2. When the boot 2 is pushed in the first direction D1 relative to the adapter, the inner housing 7 is pushed by an end portion of the boot 2 in the first direction D1 and moves along the first direction D1, and the protruding portion of the inner housing 7 engages with the latch of the adapter. FIG. 3 shows an example in which both the inner housing 7 and the second housing 8 are pushed by the end portion of the boot 2 in the first direction D1. However, only the inner housing 7 may be pushed, or only the second housing 8 may be pushed, so that the second housing 8 and the inner housing 7 move along the first direction D1. The boot 2 is rotatable relative to the second housing 8 about the axis L.

The second housing 8 has, for example, a tube portion 8d protruding in the second direction D2. The tube portion 8d has an uneven portion on an outer periphery. A caulking ring (not shown) is engaged rearward of the second housing 8. A tensile strength fiber and a sheath of the optical fiber cord are sandwiched and fixed between an outer peripheral surface of the tube portion 8d and an inner peripheral surface of the caulking ring. The optical fibers held by the ferrule described above are passed through the inside of the caulking ring.

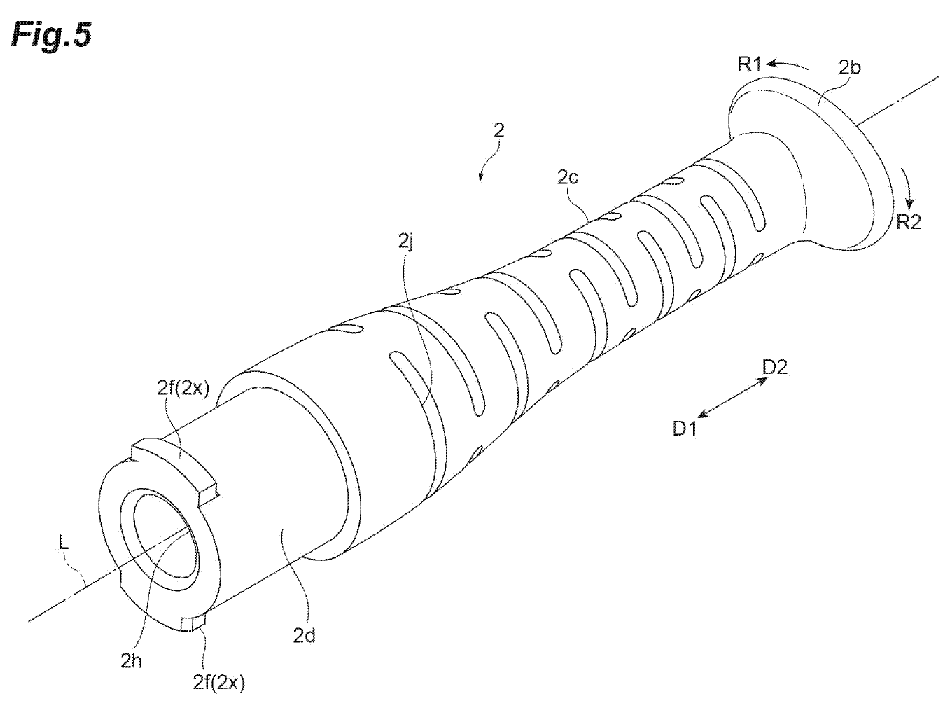

FIG. 5 is a perspective view showing the boot 2. As shown in FIG. 5, the boot 2 has a tubular shape extending along the first direction D1. The boot 2 has a through hole 2h through which the fiber cord is inserted. The through hole 2h penetrates the boot 2 in the first direction D1 (second direction D2). The boot 2 protects the optical fiber cord so that a severe bending will not be applied to the optical fiber cord. The boot 2 has a retaining portion 2f for preventing the boot 2 from coming off from the connecting component 3 in the second direction D2. The retaining portion 2f is formed, for example, at the end portion of the boot 2 in the first direction D1. The retaining portion 2f is, for example, a protruding portion 2x protruding in a direction away from the axis L. For example, when viewed along the second direction D2, the protruding portion 2x has an arc shape.

When the inner housing 7 moves along the first direction D1 at the time of insertion into the adapter, the first housing 6 is pushed by a distal end of the latch of the adapter and once retracts along the second direction D2 relative to the inner housing 7, so that the protruding portion of the inner housing 7 engages with the latch of the adapter. At this time, since the first housing 6 is provided with the recessed portion 6k (see FIG. 4), the protruding portion 2x of the boot 2 does not hinder the retraction of the first housing 6. After the protruding portion of the inner housing 7 is engaged with the latch of the adapter, the first housing 6 is separated from the distal end of the latch of the adapter, so that the first housing 6, which has been retracted along the second direction D2 relative to the inner housing 7, is returned by a predetermined distance along the first direction D1 relative to the inner housing 7 by the spring between the inner housing 7 and the first housing 6.

The boot 2 has an identification portion 2b that allows identification of a rotational position of the retaining portion 2f relative to the connecting component 3 and the second housing 8, an extending portion 2c extending from the identification portion 2b in the first direction D1, and a tubular portion 2d located forward of the extending portion 2c. The extending portion 2c has a plurality of grooves 2j. The identification portion 2b, the extending portion 2c, and the tubular portion 2d are arranged in this order along the first direction D1. The identification portion 2b is, for example, increased in diameter relative to the extending portion 2c. For example, the identification portion 2b is located at an end portion (rear end) on the rear side of the boot 2. For example, the extending portion 2c increases in diameter as it approaches the tubular portion 2d, and decreases in diameter as it approaches the identification portion 2b. Thus, the boot 2 has a shape that is easily grasped with fingers.

An outer diameter of the extending portion 2c at an end portion (front end) on the front side is larger than an outer diameter of the tubular portion 2d. The tubular portion 2d has, for example, a cylindrical shape. The retaining portion 2f (the protruding portion 2x) is formed, for example, at the front end of the tubular portion 2d. The retaining portion 2f protrudes in a direction away from the axis L, and extends along the first direction D1 (second direction D2) and the first rotation direction R1 (second rotation direction R2). For example, a length of the retaining portion 2f in the first rotation direction R1 is larger than a length of the retaining portion 2f in the first direction D1. For example, the boot 2 includes a plurality of (two, as an example) retaining portions 2f. For example, a pair of retaining portions 2f are formed at positions symmetrical relative to the axis L.

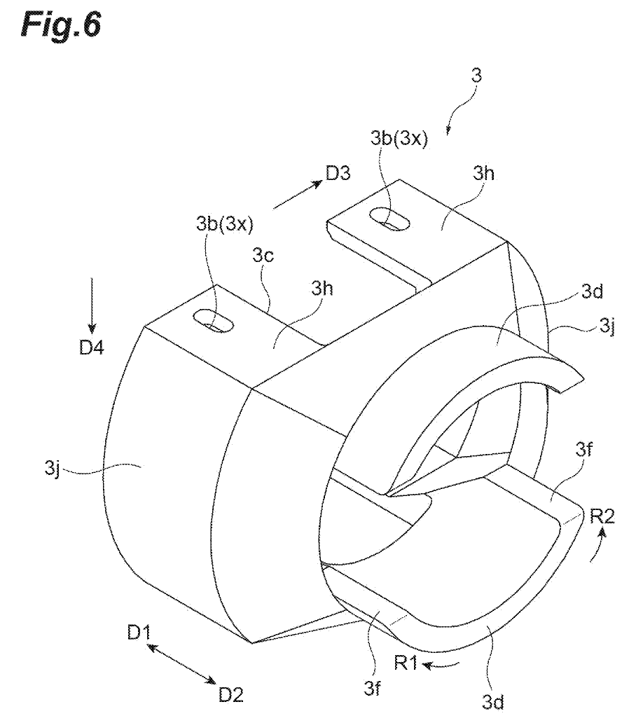

FIG. 6 is a perspective view showing the connecting component 3. As shown in FIG. 6, the connecting component 3 has, for example, a tubular portion 3d, a plate-like portion 3h extending forward from the tubular portion 3d, and an outer wall portion 3j extending along the first rotation direction R1 (second rotation direction R2) from the plate-like portion 3h. For example, when viewed along the first direction D1, the outer wall portion 3j has an arc shape. The plate-like portion 3h has, for example, a flat plate shape extending in the first direction D1 and the third direction D3 and having a thickness in the fourth direction D4. The connecting component 3 has a pair of plate-like portions 3h and a space 3c located between the pair of plate-like portions 3h. The pair of plate-like portions 3h are arranged along the third direction D3. The space 3c is an opening recessed in the second direction D2 from an end portion of the connecting component 3 in the first direction D1. When viewed along the fourth direction D4, the space 3c has a squared U-shape.

The connecting component 3 has a fixing portion 3b fixed to the first housing 6. The fixing portion 3b is, for example, a fixing hole 3x for fixing the connecting component 3 to the first housing 6. The fixing hole 3x is formed in each of the pair of plate-like portions 3h. The fixing hole 3x penetrates the plate-like portion 3h in the fourth direction D4. The fixing portion 3b has, for example, an oval shape having a long axis extending in the first direction D1 and a short axis extending in the third direction D3. For example, a pair of fixing portions 3b are arranged along the third direction D3.

The tubular portion 3d houses the end portion of the boot 2 in the first direction D1. The tubular portion 3d has, for example, a cylindrical shape. A shape of the tubular portion 3d as viewed along the first direction D1 is a circular shape. The tubular portion 3d has a slit 3f extending in the first direction D1 from an end portion of the tubular portion 3d in the second direction D2. For example, the connecting component 3 has a plurality of (two, as an example) tubular portions 3d. The plurality of tubular portions 3d are arranged along the fourth direction D4. The tubular portions 3d have, for example, a plurality of (two, as an example) slits 3f. The plurality of slits 3f are arranged along the third direction D3.

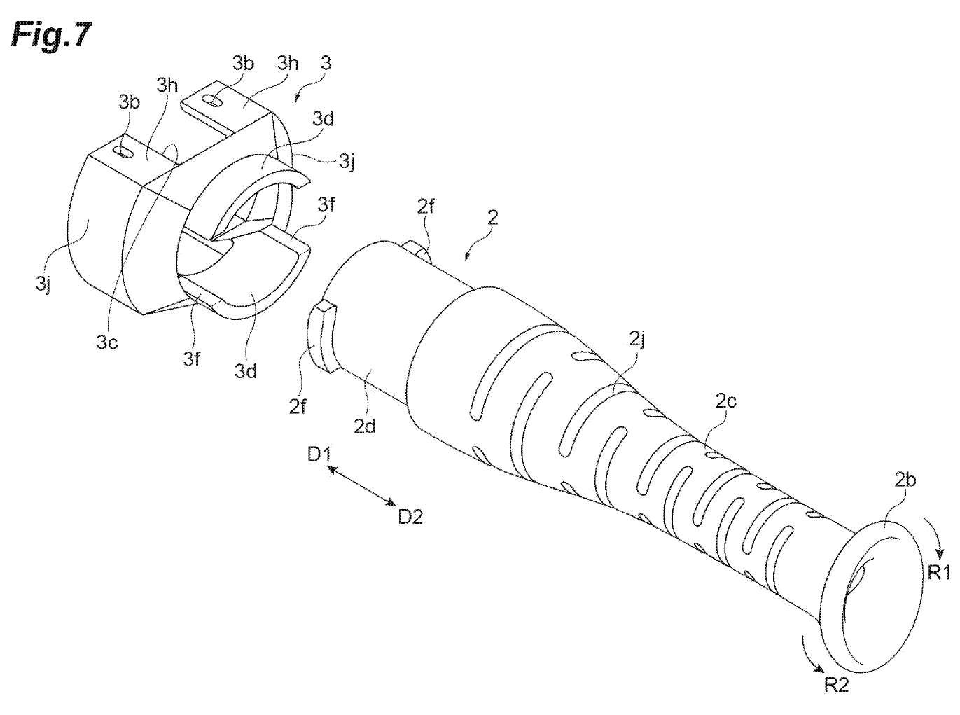

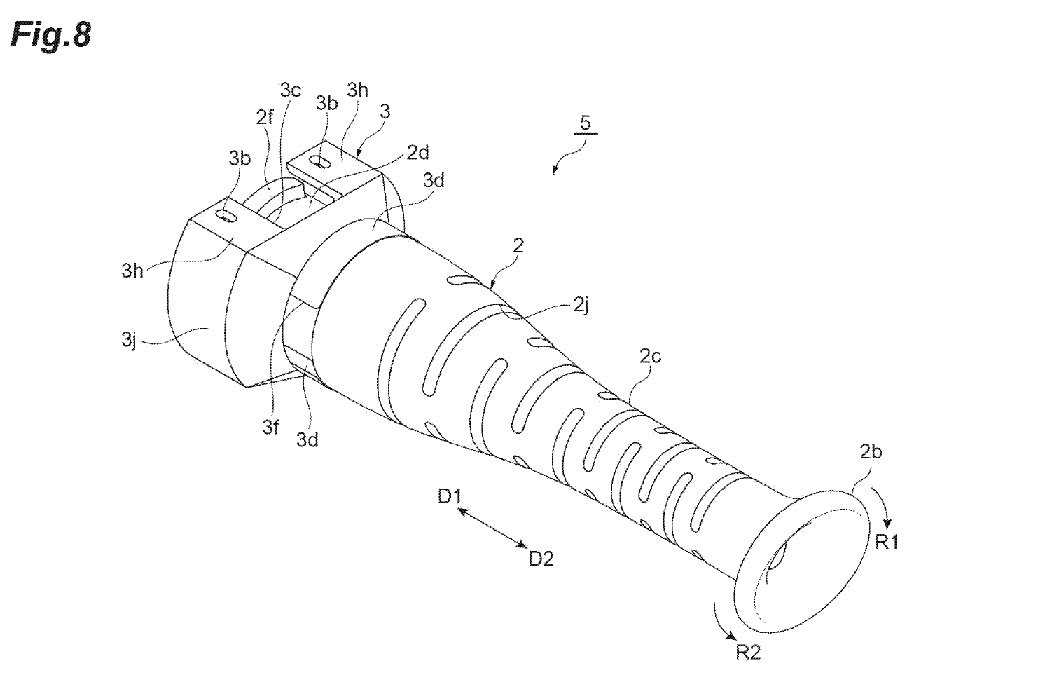

An example of a method of assembling the boot assembly 5 will be described with reference to FIGS. 7 and 8. FIG. 7 is a perspective view showing the boot 2 and the connecting component 3. FIG. 8 is a perspective view showing the assembled boot assembly 5. First, the boot 2 is disposed rearward of the connecting component 3, and the retaining portion 2f is made to face the tubular portion 3d. A position of the retaining portion 2f in the first rotation direction R1 is aligned with a position of the slit 3f in the first rotation direction R1. That is, a rotational position of the boot 2 relative to the connecting component 3 is adjusted such that the slit 3f and the retaining portion 2f are arranged along the second direction D2. The retaining portion 2f is inserted into the slit 3f along the first direction D1, and the retaining portion 2f is moved to an internal space of the connecting component 3. The internal space of the connecting component 3 indicates a space inside the connecting component 3 surrounded by the pair of plate-like portions 3h and the pair of outer wall portions 3j.

In a state in which the retaining portion 2f is located in the internal space of the connecting component 3, the boot 2 is rotated in the first rotation direction R1 (or the second rotation direction R2) relative to the connecting component 3. At this time, an amount of rotation of the boot 2 relative to the connecting component 3 is, for example, 90°. The assembly of the boot assembly 5 is completed through the above steps. At this time, the retaining portion 2f is exposed to the space 3c of the connecting component 3. When the retaining portion 2f is exposed to the space 3c, the boot 2 can be moved by a predetermined distance in the first direction D1 and the second direction D2 relative to the connecting component 3. The connecting component 3 allows the retaining portion 2f to move along the second direction D2 by a predetermined distance. When the boot 2 is pulled in the second direction D2 by a certain amount or more, the retaining portion 2f is caught in a wall of a rear end of the space 3c defining the space 3c, and the movement of the boot 2 in the second direction D2 is restricted.

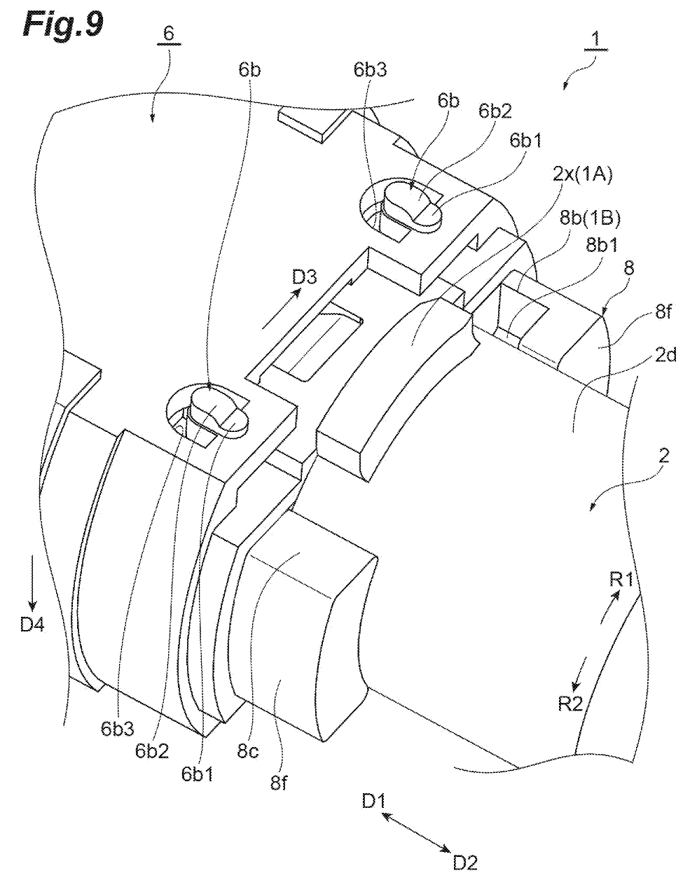

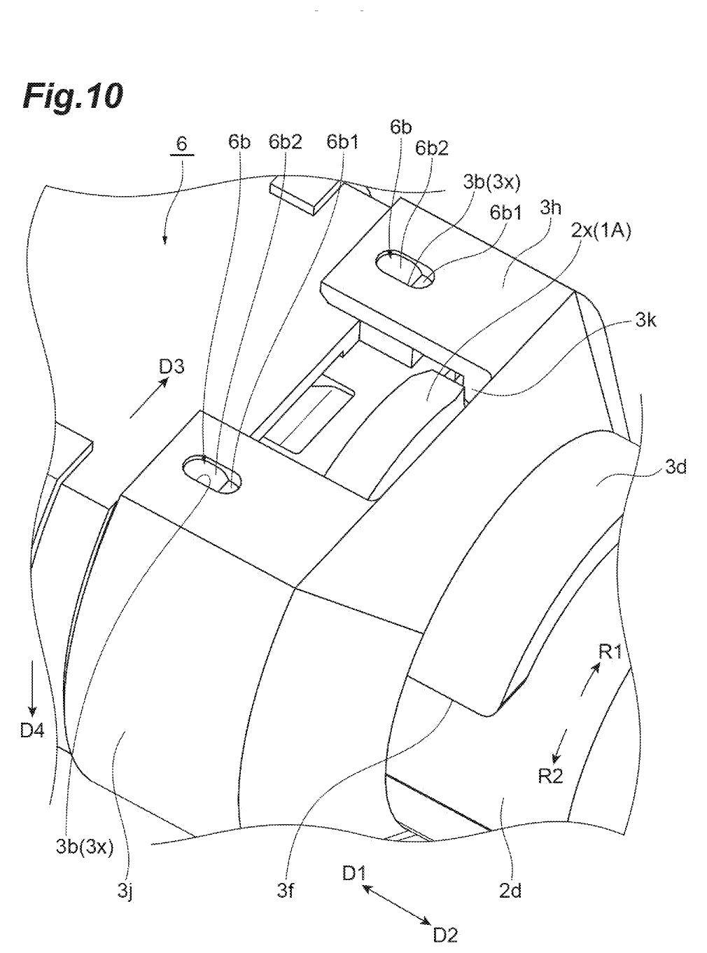

The boot 2, the connecting component 3, the first housing 6 and the second housing 8 will be described in more detail with reference to FIGS. 9 and 10. FIG. 9 is a perspective view showing the boot 2, the first housing 6, and the second housing 8 in a state where the connecting component 3 is removed. FIG. 10 is a perspective view showing a state in which the connecting component 3 is fixed to the first housing 6 of FIG. 9. The boot 2 has a first portion 1A that is the protruding portion 2x protruding in a direction away from the axis L. The first portion 1A is, for example, the retaining portion 2f described above. The second housing 8 has a second portion 1B that is a recessed portion 8b which the protruding portion 2x enters.

The second housing 8 has a storing portion 8f for storing the protruding portion 2x. The storing portion 8f has the recessed portion 8b which the protruding portion 2x enters in the first rotation direction R1. The storing portion 8f protrudes from the second housing 8 in the second direction D2. A shape of the storing portion 8f as viewed along the first direction D1 is, for example, an arc shape. The second housing 8 includes, for example, a plurality of (two, as an example) storing portions 8f. A pair of storing portions 8f are arranged along the third direction D3.

The recessed portion 8b is recessed toward the first rotation direction R1 from an end portion of one storing portion 8f in the second rotation direction R2 that is located on the third direction D3 side among the pair of storing portions 8f. For example, the recessed portion 8b has a bottom portion 8b1 that contacts the protruding portion 2x that has entered the recessed portion 8b. When the protruding portion 2x contacts the bottom portion 8b1, the rotation of the protruding portion 2x in the first rotation direction R1 is restricted. For example, the second housing 8 has a wall portion 8c located at an end portion of the other storing portion 8f in the first rotation direction R1 that is located opposite side in the third direction D3 among the pair of storing portions 8f.

The connecting component 3 covers the end portion of the first housing 6 in the second direction D2. For example, the end portion of the first housing 6 in the second direction D2 is housed in the internal space of the connecting component 3. The first housing 6 has a projection 6b that enters the fixing hole 3x of the connecting component 3, and a hole portion 6b3 that is recessed around the projection 6b. For example, the first housing 6 includes a plurality of projections 6b and a plurality of hole portions 6b3. The plurality of projections 6b are arranged along the third direction D3. The plurality of hole portions 6b3 are arranged along the third direction D3.

The connecting component 3 is fixed to the first housing 6 by the projection 6b formed in the first housing 6 entering the fixing hole 3x. The projection 6b includes, for example, a flat portion 6b1 and an inclined portion 6b2 extending forward and obliquely upward relative to the flat portion 6b1. The flat portion 6b1 extends in the first direction D1 and the third direction D3 and has a thickness in the fourth direction D4. In the inclined portion 6b2, a projection height of the projection 6b decreases toward the second direction D2. The inclined portion 6b2 has, for example, a curved surface shape.

The hole portion 6b3 penetrates the first housing 6 in the fourth direction D4, for example. The hole portion 6b3 is formed at a position surrounding the projection 6b when viewed along the fourth direction D4. For example, the hole portion 6b3 has a U-shape when viewed along the fourth direction D4. The hole portion 6b3 is located, for example, at the first direction D1, the third direction D3, and an opposite direction to the third direction D3 of the projection 6b.

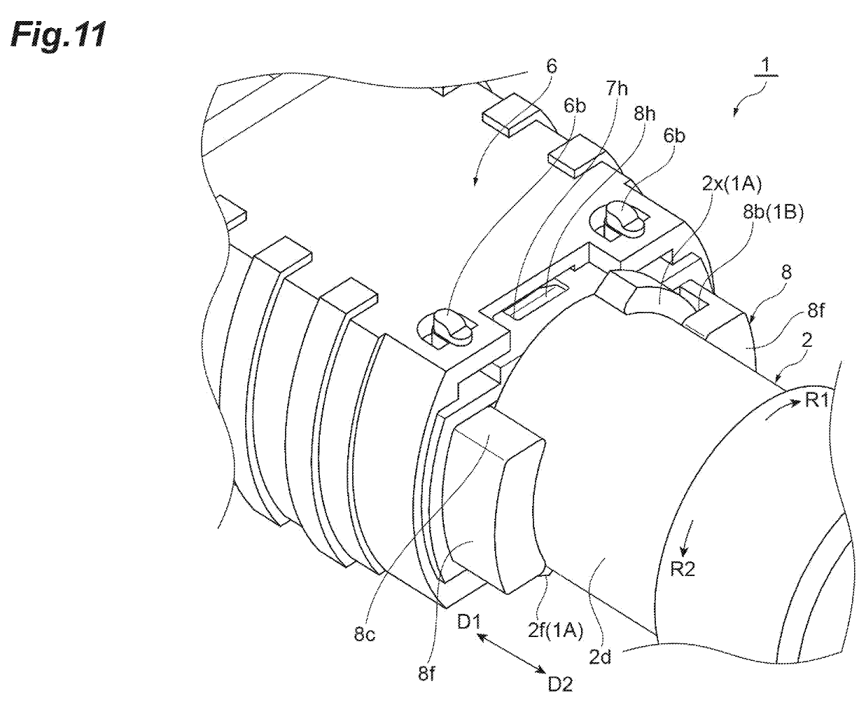

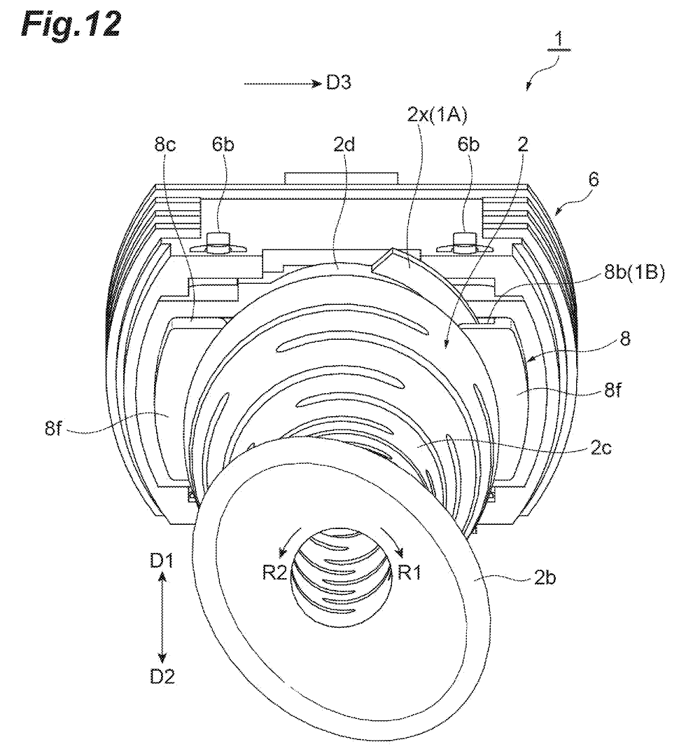

FIG. 11 is a perspective view showing a state in which the boot 2 of FIG. 9 is rotated in the first rotation direction R1. FIG. 12 is a perspective view of the connector 1 of FIG. 11 as viewed from the rearward. As shown in FIGS. 9, 11 and 12, when the boot 2 is rotated relative to the second housing 8 in the first rotation direction R1, the protruding portion 2x enters the recessed portion 8b. At this time, the movement of the boot 2 relative to the second housing 8 in the second direction D2 is restricted by the protruding portion 2x of the boot 2 entering the recessed portion 8b of the storing portion 8f in the first rotation direction R1. The protruding portion 2x enters the recessed portion 8b, and the movement of the boot 2 relative to the second housing 8 in the second direction D2 is restricted, whereby the movement of the first housing 6 in the second direction D2 due to the movement of the boot 2 does not occur, and thus the connector 1 transitions to a locked state in which the connector 1 cannot be detached from the adapter. In addition, in the locked state, the first housing 6 is restricted from movement in the second direction D2 by the protruding portion 2x rotated in the first rotation direction R1 being located at the end portion of the first housing 6 in the second direction D2. Even if only the first housing 6 is pulled in the second direction D2, the connector 1 is not detached from the adapter.

The boot 2 becomes movable relative to the second housing 8 in the second direction D2 by the protruding portion 2x coming off from the recessed portion 8b when the boot 2 is rotated relative to the second housing 8 in the second rotation direction R2 opposite to the first rotation direction R1. At this time, the connector 1 transitions to an unlocked state in which the connector 1 can be detached from the adapter. In the unlocked state, when the boot 2 is pulled in the second direction D2, the connecting component 3 and the first housing 6 move a predetermined distance relative to the inner housing 7, and the protruding portion of the inner housing 7 is in a state of being able to be released from the latch of the adapter. Thereafter, the inner housing 7 moves in the second direction D2, and by disengaging the protruding portion of the inner housing 7 from the latch of the adapter, the connector 1 is detached from the adapter.

The identification portion 2b of the boot 2 is a portion that allows identification of whether the connector 1 is in the locked state or the unlocked state. The identification portion 2b has, for example, a non-circular shape. As an example, the identification portion 2b has an elliptical shape. In this case, it is possible to identify whether the connector 1 is in the locked state or the unlocked state by viewing a direction of a long axis of the identification portion 2b. For example, when the direction in which the long axis of the identification portion 2b extends matches the third direction D3, the connector 1 is in the unlocked state, and when the direction in which the long axis of the identification portion 2b extends is obliquely extended relative to the third direction D3, the connector 1 is in the locked state.

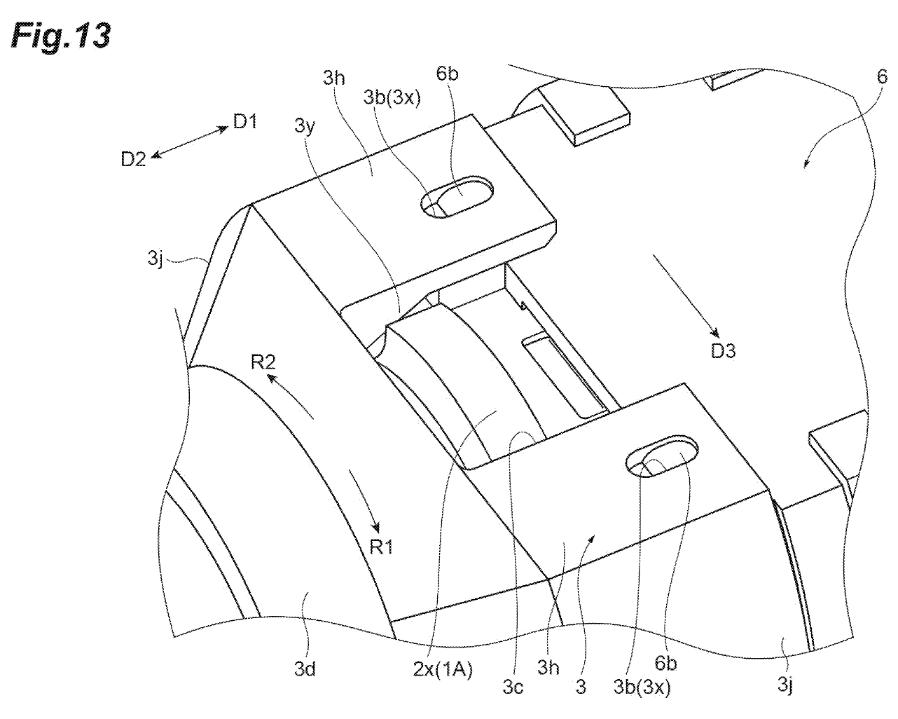

FIG. 13 is a perspective view showing the protruding portion 2x, the connecting component 3, and the first housing 6. As shown in FIG. 13, for example, the connecting component 3 has a wall portion 3y configured such that the protruding portion 2x contacts the wall portion 3y when the boot 2 moves in the second rotation direction R2. The wall portion 3y is formed on one of the pair of plate-like portions 3h arranged along the third direction D3, for example. The plate-like portion 3h located on the second rotation direction R2 side of the space 3c has the wall portion 3y, and the plate-like portion 3h located on the first rotation direction R1 side of the space 3c does not have the wall portion 3y. The wall portion 3y is, for example, a portion that is thick in the plate-like portion 3h, and the plate-like portion 3h becomes thicker toward the rearward in the wall portion 3y. In a state where the protruding portion 2x contacts the wall portion 3y, the rotation of the boot 2 in the second rotation direction R2 relative to the connecting component 3 is restricted.

Next, effects obtained from the connector 1 and the boot assembly 5 will be described. In the boot assembly 5, the boot 2 extends from the first housing 6 of the connector 1 in the second direction D2. The boot assembly 5 includes the connecting component 3, and the connecting component 3 connects the boot 2 to the first housing 6. The boot 2 has the retaining portion 2f for preventing the boot 2 from coming off from the connecting component 3 fixed to the first housing 6 in the second direction D2. The connecting component 3 has the fixing portion 3b to be fixed to the first housing 6 and the space 3c that allows the retaining portion 2f of the boot 2 to be movable by a predetermined distance along the second direction D2. Thus, when the boot 2 is pulled in the second direction D2, the retaining portion 2f moves a predetermined distance relative to the connecting component 3, and the retaining portion 2f prevents the boot 2 from coming off from the first housing 6 and the connecting component 3. Thus, even when the boot 2 is pulled, the boot 2 is prevented from coming off from the first housing 6 and the connecting component 3, so that the boot 2 can be made less likely to be detached.

The material of the connecting component 3 may be harder than the material of the boot 2. In this case, the material of the connecting component 3 is harder than the material of the boot 2, and thus it is possible to reduce deflection of the connecting component 3 when an external force is applied. Thus, the boot assembly 5 can be prevented from coming off from the first housing 6.

The boot 2 may be rotatable relative to the connecting component 3 about the axis L extending along the first direction D1. The retaining portion 2f may be the protruding portion 2x protruding in a direction away from the axis L. In this case, the retaining portion 2f is the protruding portion 2x, and thus the retaining portion 2f can be easily visually recognized.

The space 3c may be an opening recessed in the second direction D2 from the end portion of the connecting component 3 in the first direction D1. In this case, the configuration of the space 3c can be simplified.

The connecting component 3 may have the tubular portion 3d that houses the end portion of the boot 2 in the first direction D1. The tubular portion 3d may have the slit 3f extending in the first direction D1 from the end portion of the tubular portion 3d in the second direction D2. In this case, tilting of the boot 2 located inside the tubular portion 3d can be reduced, and the movement of the boot 2 can be stabilized.

The fixing portion 3b may be the fixing hole 3x into which the projection 6b formed in the first housing 6 enters to fix the connecting component 3 to the first housing 6. In this case, the shape of the fixing portion 3b of the connecting component 3 can be simplified. The projection 6b may have the inclined portion 6b2 where the projection height of the projection 6b decreases toward the second direction D2. In this case, the projection 6b has the inclined portion 6b2, which is a portion where the projection height decreases toward the second direction D2, which is the direction in which the boot 2 is pulled. Thus, since the projection height of the projection 6b increases toward the first direction D1, which is the direction in which the boot 2 is pushed, the projection 6b can be more reliably prevented from coming off when the boot 2 is pulled in the second direction D2.

The first housing 6 may have the hole portion 6b3 recessed around the projection 6b. In this case, the hole portion 6b3 is formed around the projection 6b, and thus the projection 6b can be easily deflected.

In the connector 1, the second housing 8 is located inside the first housing 6, and the end portion of the second housing 8 in the second direction D2 protrudes from the first housing 6. The boot 2 extends from the second housing 8 in the second direction D2, and the connecting component 3 fixed to the first housing 6 connects the boot 2 to the first housing 6. The boot 2 is rotatable about the axis L extending along the first direction D1, and has the first portion 1A that is the protruding portion 2x protruding in the direction away from the axis L. The second housing 8 has the second portion 1B that is the recessed portion 8b. When the boot 2 is rotated relative to the second housing 8 in the second rotation direction R2, the protruding portion 2x comes out of the recessed portion 8b, thereby entering the unlocked state in which the boot 2 becomes movable relative to the second housing 8 in the second direction D2. When the boot 2 is rotated relative to the second housing 8 in the first rotation direction R1, the protruding portion 2x enters the recessed portion 8b, thereby entering the locked state in which the movement of the boot 2 relative to the second housing 8 in the second direction D2 is restricted. At this time, even if the boot 2 is unintentionally pulled in the second direction D2, the movement of the boot 2 in the second direction D2 is restricted. Thus, the movement of the boot 2 is restricted, and thereby the connector 1 can be prevented from being accidentally detached from the adapter.

The first portion 1A of the boot 2 may be the protruding portion 2x, and the second portion 1B of the second housing 8 may be the recessed portion 8b. In this case, since the first portion 1A of the rotating boot 2 is the protruding portion 2x, it is possible to easily recognize whether or not the movement of the boot 2 is restricted by viewing the rotational position of the protruding portion 2x. Thus, whether the connector 1 is in the locked state or the unlocked state can be easily recognized by viewing the rotational position of the protruding portion 2x of the boot 2.

The movement of the first housing 6 in the second direction D2 may be restricted by the protruding portion 2x that has entered the recessed portion 8b being located in the second direction D2 from the first housing 6 when the boot 2 is rotated relative to the second housing 8 in the first rotation direction R1. In this case, the protruding portion 2x that has entered the recessed portion 8b restricts the movement of the first housing 6 in the second direction D2, and thus the movement of the first housing 6 in the second direction D2 can be restricted as well as the boot 2. Thus, the connector 1 can be more reliably prevented from being accidentally detached from the adapter.

The recessed portion 8b may have the bottom portion 8b1 configured to contact the protruding portion 2x that has entered the recessed portion 8b to restrict the rotation of the protruding portion 2x in the first rotation direction R1. In this case, the protruding portion 2x can be prevented from being excessively rotated in the first rotation direction R1 by the protruding portion 2x contacting the bottom portion 8b1.

The connecting component 3 may have the wall portion 3y configured such that the protruding portion 2x contacts the wall portion 3y when the boot 2 is rotated in the second rotation direction R2. In this case, the protruding portion 2x can be prevented from being excessively rotated in the second rotation direction R2 by the protruding portion 2x contacting the wall portion 3y.

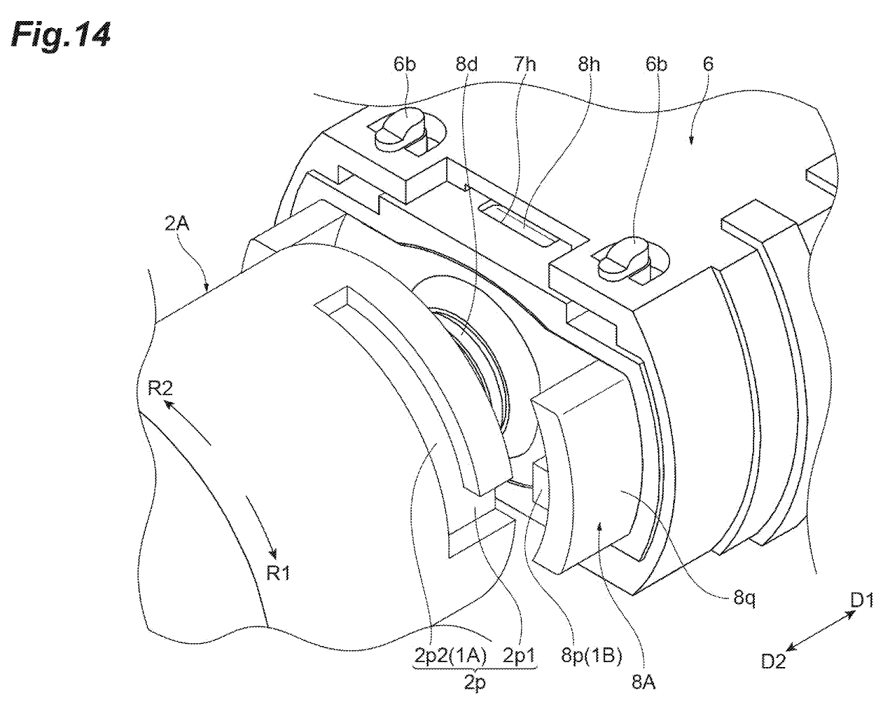

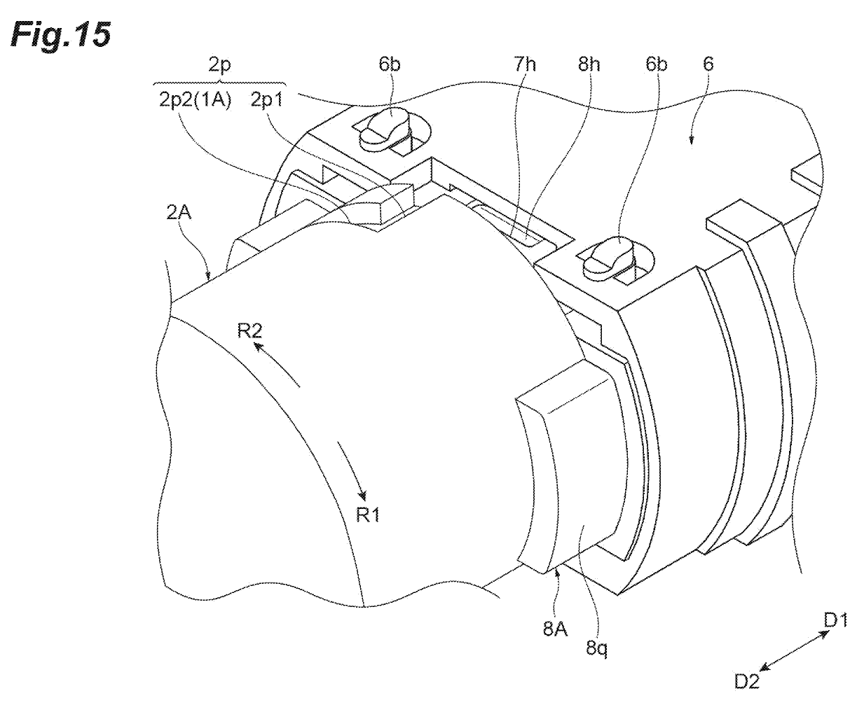

Next, a connector related to a modification will be described. FIG. 14 is a perspective view showing a boot 2A and a second housing 8A of the connector related to the modification. FIG. 15 is a perspective view showing a state in which the boot 2A of FIG. 14 is joined to the second housing 8A and rotated in the first rotation direction R1. A part of the configuration of the connector according to the modification is the same as a part of the configuration of the connector 1 described above. In the following description, the same reference numerals are given to the same components as those of the connector 1, and the description thereof will be omitted as appropriate.

In the connector 1 described above, an example in which the first portion 1A of the boot 2 is the protruding portion 2x and the second portion 1B of the second housing 8 is the recessed portion 8b has been described. In contrast, in the connector according to the modification, the first portion 1A of the boot 2A is a recessed portion 2p2, and the second portion 1B of the second housing 8A is a protruding portion 8p. The boot may have a first portion that is either the protruding portion or the recessed portion, and the second housing may have a second portion that is the protruding portion when the first portion is the recessed portion and is the recessed portion when the first portion is the protruding portion, and whether the protruding portion and the recessed portion are formed in the boot or the second housing can be changed as appropriate.

The boot 2A includes a depression 2p. The depression 2p includes the recessed portion 2p2 extending in the first rotation direction R1 and a connecting portion 2p1 connecting an end portion of the recessed portion 2p2 in the first rotation direction R1 and an end portion of the boot 2A in the first direction D1 to each other. The second housing 8A has a projecting portion 8q projecting in the second direction D2 in the second housing 8A, and the protruding portion 8p projecting from the projecting portion 8q toward the tube portion 8d. The protruding portion 8p enters the connecting portion 2p1 along the second direction D2. The protruding portion 8p enters the recessed portion 2p2 along the second rotation direction R2.

When the boot 2A is rotated relative to the second housing 8A in the first rotation direction R1 in a state in which the protruding portion 8p is located at an end portion of the connecting portion 2p1 in the second direction D2, the protruding portion 8p enters the recessed portion 2p2. At this time, the protruding portion 8p is located in the recessed portion 2p2 extending in the first rotation direction R1, so that the movement of the boot 2A relative to the second housing 8A in the second direction D2 is restricted, and the connector according to the modification transitions to the locked state. When the boot 2A is rotated relative to the second housing 8A in the second rotation direction R2, the protruding portion 8p enters the connecting portion 2p1. At this time, the protruding portion 8p is located at the connecting portion 2p1 extending in the second direction D2, and thus the connector according to the modification transitions to the unlocked state in which the boot 2A is movable relative to the second housing 8A in the second direction D2.

As described above, in the connector according to the modification, the boot 2A has the first portion 1A that is the recessed portion 2p2 recessed in the direction toward the axis L, and the second housing 8A has the second portion 1B that is the protruding portion 8p different from the first portion 1A. When the boot 2A is rotated relative to the second housing 8A in the second rotation direction R2, the protruding portion 8p comes out of the recessed portion 2p2, thereby entering the unlocked state in which the boot 2A is movable relative to the second housing 8A in the second direction D2. When the boot 2A is rotated relative to the second housing 8A in the first rotation direction R1, the protruding portion 8p enters the recessed portion 2p2, thereby entering the locked state in which the movement of the boot 2A relative to the second housing 8A in the second direction D2 is restricted. At this time, even if the boot 2A is unintentionally pulled in the second direction D2, the movement of the boot 2A in the second direction D2 is restricted, and thus the connector can be prevented from being accidentally detached from the adapter, and thus effects similar to those of the connector 1 described above can be obtained.

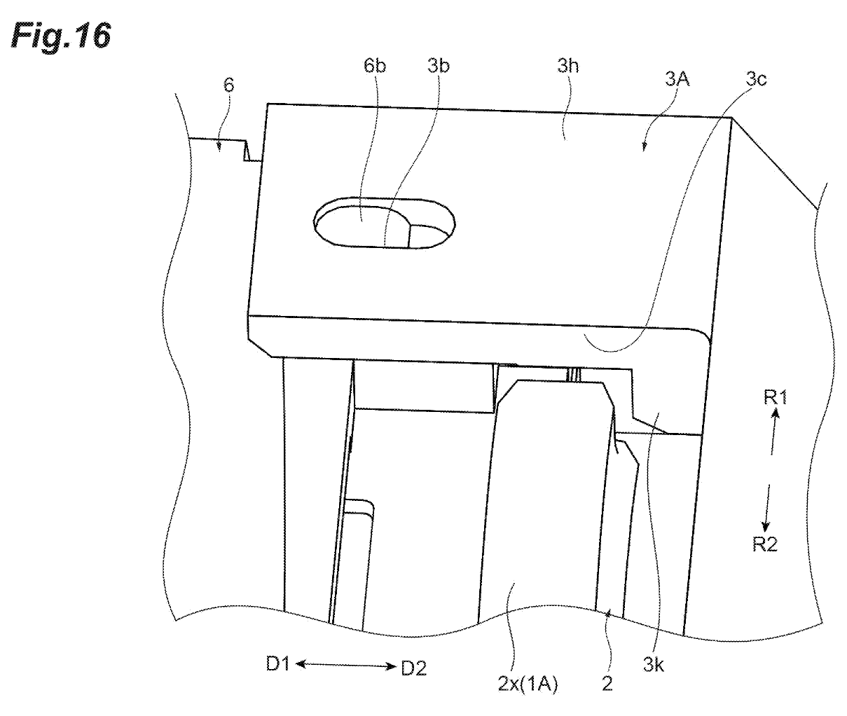

FIG. 16 is a perspective view showing a connecting component 3A of the connector according to the modification. The connecting component 3A has an interfering portion 3k configured such that the protruding portion 2x of the boot 2 contacts the interfering portion 3k in the first rotation direction R1 when the boot 2 moves in the second direction D2. The interfering portion 3k is formed in the plate-like portion 3h located in the first rotation direction R1 of the space 3c. The interfering portion 3k is a portion where the plate-like portion 3h is thickened at a rear end of the plate-like portion 3h, and is located rearward of the protruding portion 2x. The connecting component 3A has the interfering portion 3k configured such that the protruding portion 2x of the boot 2 contacts the interfering portion 3k in the first rotation direction R1 when the boot 2 moves in the second direction D2. In this case, it is possible to prevent the boot 2 from being unintentionally rotated and entering the locked state.

The embodiments and various modifications of the connector and boot assembly according to the present disclosure have been described above. However, the connector and the boot assembly according to the present disclosure are not limited to the contents of the above-described embodiments or modifications, and may be modified within the scope of the gist described in the claims. That is, the shape, size, material, number, and arrangement of each part of the connector and the boot assembly according to the present disclosure can be appropriately changed within the scope of the above gist.

For example, in the above-described embodiment, the boot 2 having the identification portion 2b of a non-circular shape has been described. However, the shape of the identification portion of the boot need not be a non-circular shape, and is not particularly limited. The identification portion may be a mark indicating a rotational position of the boot. In this manner, the form of the identification portion can be changed as appropriate.

In the above-described embodiment, the first housing 6 including the projection 6b having the flat portion 6b1 and the inclined portion 6b2 has been described. However, the first housing may have a projection having an inclined surface that becomes higher toward the first direction D1, instead of the projection 6b. In this manner, the shape of the projection of the first housing can be changed as appropriate.

In the above-described embodiment, an example in which the end portion of the first housing 6 in the second direction D2 is housed in the internal space of the connecting component 3 has been described. However, the end portion of the connecting component in the first direction D1 may be housed in the internal space of the first housing. In this manner, the relationship of the arrangement of the connecting component and the first housing can be changed as appropriate.

In the above-described embodiment, the connecting component 3 having the space 3c having a squared U-shape has been described. However, the connecting component may be a connecting component in which the space 3c is not formed. For example, the connecting component may have a plate-like portion covering the protruding portion 2x of the boot 2, and an inner groove in which the protruding portion 2x is movable may be formed in an inner surface of the plate-like portion.

In the above-described embodiment, the second housing 8 including the recessed portion 8b having the bottom portion 8b1 has been described. However, the second housing may include a recessed portion that does not have the bottom portion 8b1. In this case, since the storing portion 8f does not have the bottom portion 8b1, the rotation of the boot 2 relative to the second housing 8 is not restricted. However, the recessed portion 8b having the bottom portion 8b1 can make it easier to understand whether the connector is in the locked state or the unlocked state.

What is claimed is:

1. A boot assembly for a connector connectable to an adapter along a first direction and detachable from the adapter by being pulled in a second direction opposite to the first direction, the boot assembly comprising:
a boot extending from a housing of the connector in the second direction; and
a connecting component configured to connect the boot to the housing,
wherein the boot includes a retaining portion configured to prevent the boot from coming off in the second direction relative to the connecting component, and
wherein the connecting component includes a fixing portion to be fixed to the housing and a space allowing the retaining portion to move by a predetermined distance relative to the connecting component along the second direction.

2. The boot assembly according to claim 1,
wherein a material of the connecting component is harder than a material of the boot.

3. The boot assembly according to claim 1,
wherein the boot is rotatable relative to the connecting component about an axis extending along the first direction, and
wherein the retaining portion is a protruding portion protruding in a direction away from the axis.

4. The boot assembly according to claim 1,
wherein the space is an opening recessed from an end portion of the connecting component in the first direction toward the second direction.

5. The boot assembly according to claim 1,
wherein the connecting component includes a tubular portion configured to house an end portion of the boot in the first direction, and
wherein the tubular portion includes a slit extending in the first direction from an end portion of the tubular portion in the second direction.

6. The boot assembly according to claim 1,
wherein the fixing portion is a fixing hole configured such that the connecting component is fixed to the housing by a projection formed in the housing entering the fixing hole.

7. A connector comprising:
the boot assembly according to claim 1; and
a housing to which the connecting component of the boot assembly is fixed.

8. The connector according to claim 7,
wherein the housing includes a projection,
wherein the connecting component includes a fixing hole configured such that the connecting component is fixed to the housing by the projection entering the fixing hole, and
wherein the projection includes an inclined portion where a projection height of the projection decreases toward the second direction.

9. The connector according to claim 7,
wherein the housing includes a projection and a hole portion recessed around the projection.
